(19) United States
(12) Patent Application Publication
(10) Pub. No.: US 2009/0004331 A1
(43) Pub. Date: Jan. 1, 2009

(54) Process of Producing Rooibos Tea Extract

(76) Inventors: Marinda Bloom, Stellenbosch (ZA); Willem Heber Van Zyl, Stellenbosch (ZA); Elizabeth Joubert, Somerset Wes (ZA); Alfred Botha, Somerset West (ZA); Dawie De Villiers, Brackenfell (ZA)

Correspondence Address: LADAS & PARRY LLP, 26 WEST 61ST STREET, NEW YORK, NY, 10023, US

(21) Appl. No.: 11/658,439

(22) PCT Filed: Jul. 25, 2005
(86) PCT No.: PCT/IB05/52490

§ 371 Date: Jan. 26, 2007

(30) Foreign Application Priority Data
Jul. 29, 2004 (ZA) 2004/6073

(51) Int. Cl. A23F 3/10

(52) U.S. Cl. 426/50; 426/52

(57) ABSTRACT

The invention provides a process of treating Rooibos plant material to obtain Rooibos tea extracts with improved extract yield and colour development. The process includes contacting Rooibos plant material with an effective amount of at least one exogenous enzyme under predetermined conditions thereby to obtain Rooibos tea extracts having improved extract yield and colour development. The enzyme is selected from pectinase, ferulic acid esterase, β-glucanase, cellobiohydrolase, β-xylanase and phenol oxidase and the Rooibos plant material is selected from green tea, fermented tea or spent tea.

THIS INVENTION relates to Rooibos tea, and more particularly to a process of treating Rooibos plant material to obtain Rooibos tea extracts with improved extract yield and/or colour development.

Aspelathus linearis is a unique South-African fynbos plant cultivated for the production of Rooibos tea. Rooibos tea is made from the stalks and leaves of the plant, which are shredded and bruised, followed by a long period of open-air oxidation (‘fermentation’) and sun-drying to allow for development of the characteristic Rooibos colour and flavour. Processed plant material is then cut and packaged as loose leaves or in tea bags. This processed material is referred to as ‘fermented’ Rooibos tea”. ‘Green’ or ‘fresh’ Rooibos tea refers to the unfermented Rooibos plant material that is dried and cut without exposure to air and sunlight.

Health-promoting properties associated with Rooibos tea include relief of insomnia, nervous tension, mild depression, stomach cramps, constipation and allergic symptoms. Flavonoids in Rooibos tea have strong antioxidant and free radical scavenging activities and have the potential to act as anti-carcinogenic and anti-arteriosclerotic agents. Rooibos tea and products derived therefrom are valuable for use in food/nutraceutical, pharmaceutical and/or cosmetic industry and markets.

Problems experienced in the Rooibos industry include long oxidation periods and associated loss of antioxidants during fermentation of Rooibos tea and also low solubility of Rooibos tea components.

The long oxidation period (usually about 14 to 16 hours) results in a significant loss of antioxidants in the processed tea, and therefore also a loss or reduction in its pharmaceutical and/or nutraceutical value. Furthermore, due to the unhygienic nature of conventional Rooibos tea processing from green Rooibos tea to fermented Rooibos tea, the absence of Good Manufacturing Practice (GMP) and Hazard Analysis and Critical Control Point (HACCP), and lack of control over processing conditions, the Rooibos industry may experience resistance from buyers to this kind of processing.

Rooibos plant composition results in a low solubility of Rooibos tea components and thus low yields of cold-water and warm-water soluble matter. Approximately 20% of traditional Rooibos tea is soluble in hot water in comparison to as much as 40% for black tea. Yields of soluble matter or compounds may further be reduced due to poor extraction of these compounds (50-60% soluble solids) due to their chemical nature. The problem of low yields is compounded by the necessity to separate the soluble matter or compounds in a cold-water soluble fraction for the production of iced tea and a hot-water soluble fraction of lower value.

During conventional processing of Rooibos tea, bruising of the Rooibos tea leaves appears to assist with the release of endogenous plant enzymes that contribute to the characteristic aroma and colour of Rooibos tea.

Quality parameters for Rooibos extracts include total soluble solids (SS), total polyphenols (TP), antioxidant activity and colour.

Rooibos extracts refer to the product obtained after extraction of soluble matter from green or fermented Rooibos plant material. Rooibos tea made by infusion contains soluble matter extracted from the tea leaves with hot water, whereas commercial extraction processes are based on hot water or solvent-based methods to improve the efficacy of the extraction. The yield in soluble matter is expressed as % soluble solids (gram soluble solids per 100 ml extract). An improved extract yield will therefore refer to an increased amount of soluble solids obtained per 100 ml extract.

Extract colour refers to the colour intensity of the tea extract, whether it was obtained from tea made by infusion or concentrated extracts prepared by commercial extraction processes. The characteristic red-brown colour of Rooibos tea is associated with fermented Rooibos tea, whereas green or fresh Rooibos tea has a greenish colour that develops into a red-brown colour when further oxidised. Colour development of Rooibos extracts is therefore associated with the degree of fermentation, with “improved colour development” being associated with increased levels of colour determinants or the improved extraction thereof.

According to the invention, there is provided a process of treating Rooibos plant material to obtain Rooibos tea extracts with improved extract yield and/or colour development, said process including
contacting Rooibos plant material with an effective amount of at least one exogenous enzyme under predetermined conditions thereby to obtain Rooibos tea extracts having an improved extract yield and/or colour development.

The enzyme may be selected from at least one of the group consisting of pectinase, ferulic acid esterase, β-glucanase, cellobiohydrolase, β-xylanase and phenol oxidase.

According to one aspect of the invention, there is provided a process of treating Rooibos plant material to obtain Rooibos tea extracts with improved extract yield and/or colour development, which process includes contacting Rooibos plant material with an effective amount of pectinase under suitable conditions to obtain Rooibos tea extracts.

According to one aspect of the invention, there is provided a process of treating Rooibos plant material to obtain Rooibos tea extracts with improved extract yield and/or colour development, which process includes
contacting Rooibos plant material with an effective amount of ferulic acid esterase under suitable conditions to obtain Rooibos tea extracts.

According to one aspect of the invention, there is provided a process of treating Rooibos plant material to obtain Rooibos tea extracts with improved extract yield and/or colour development, which process includes contacting Rooibos plant material with an effective amount of β-glucanase under suitable conditions to obtain Rooibos tea extracts.

According to one aspect of the invention, there is provided a process of treating Rooibos plant material to obtain Rooibos tea extracts with improved extract yield and/or colour development, which process includes
contacting Rooibos plant material with an effective amount of cellobiohydrolase under suitable conditions to obtain Rooibos tea extracts.

According to one aspect of the invention, there is provided a process of treating Rooibos plant material to obtain Rooibos tea extracts with improved extract yield and/or colour development, which process includes
contacting Rooibos plant material with an effective amount of β-xylanase under suitable conditions to obtain Rooibos tea extracts.

According to one aspect of the invention, there is provided a process of treating Rooibos plant material to obtain Rooibos tea extracts with improved extract yield and/or colour development, which process includes
contacting Rooibos plant material with an effective amount of phenol oxidase under suitable conditions to obtain Rooibos tea extracts.

According to a further aspect of the invention, there is provided a process of treating Rooibos plant material to obtain Rooibos tea extracts with improved extract yield and/or colour development, which process includes
contacting Rooibos plant material with an effective amount of at least one enzyme selected from the group consisting of a pectinase, ferulic acid esterase, β-glucanase, cellobiohydrolase, β-xylanase and phenol oxidase under suitable conditions to obtain Rooibos tea extracts.

As mentioned above, the process may include individual enzymes or any combination of the enzymes listed.

The Rooibos plant material may be green tea, fermented tea or spent tea (waste fermented material after primary extraction of soluble solids).

The process may also include contacting Rooibos plant material prior to, simultaneously with, or after the enzyme treatment or contact step with at least one or more further enzymes selected from β-glucosidase, β-xylosidase, α-arabinofuranosidase, α-glucuronidase, β-mannanase, β-mannosidase, laccase, Mn²⁺/lignin or other phenol oxidases. It will be appreciated that other suitable enzymes may also be employed in the process of the invention.

The enzyme or enzymes may be commercially available enzymes or enzymes derived from fungal strains. Preferably the enzymes are hydrolase or oxidase enzymes. The process may include the step of hydrolysing and/or oxidizing Rooibos tea plant material with said enzyme or combination of enzymes. Glycosidic bonds linking polyphenols to the cellulose backbone of the plant material may be hydrolysed and polyphenols in the plant material may be oxidised by said enzymes.

Hydrolase or oxidase enzymes may be obtained from fungal strains. Fungal strains from which enzymes may be obtained for use in the processes of the invention may be isolated from fresh, green, fermented or spent Rooibos tea. The fungal strains may be isolated from the environment such as from decaying plant material.

The process of the invention may be carried out at a temperature of 20° C. to 70° C., preferably 30° C.-60° C., e.g. 40° C.

The process of the invention may be carried out with one or more enzymes at a dosage of 0.001 U-1000 U per g tea, preferably 0.1 U-100 U per g tea, e.g. 1 U per g tea.

The process of the invention may be carried out for a period of 1-6 hours, preferably 1.5-4 hours, e.g. 2 hours.

The process of the invention may be carried out at a pH of 4-7, preferably pH 5-6,

e.g. pH 5.5.

The process may include a water and/or solvent-based process.

According to a further aspect of the invention, there is provided a process of treating Rooibos plant material to obtain Rooibos tea extracts with improved extract yield, said process including
contacting Rooibos plant material with at least one enzyme derived from at least one fungal strain under predetermined conditions to allow the enzyme to hydrolyse and/or oxidize the Rooibos plant material thereby to obtain Rooibos tea extracts having an improved extract yield.

The fungal strain may be selected from Aspergillus, Lentinula, Penicillium, Pleurotus, Trichoderma, Rhizopus, Rhizomucor, Neurospora and Paecilomyces species.

The fungal strain may be any suitable fungal strain such as Aspergillus aculeatus, Aspergillus ficuum, Aspergillus japonicus, Aspergillus niger, Aspergillus terreus, Lentinula edodes, Penicillium candidum, Pleurotus citzinopileatus, Pleurotus djamor, Pleurotus ostreatus var. florida, Trichoderma reesei, Rhizopus oryzae, Rhizomucor pusillus, Neurospora sitophila, Paecilomyces variotti, or Aspergillus tubingensis.

The applicant believes that many of the flavour and medicinal/neutraceutical compounds in Rooibos tea are trapped within the cellulolytic plant material of Rooibos as glycoconjugated aroma and phenolic compounds. These compounds may only effectively be released by enzymatic cleavage of the relevant chemical bonds. The applicant believes that polysaccharases targeted at the cellulolytic material may macerate the complex polysaccharide structures of Rooibos tea leaves, while enzymes targeted at the glycosidic bonds may assist in the release of the polyphenols.

Unless otherwise defined, all technical and scientific terms used herein have the same meaning as commonly understood by one of ordinary skill in the art to which this invention pertains. In case of conflict, the present document will be used to determine the meaning of any term. Preferred methods and materials are described below, although methods and materials similar or equivalent to those described herein can be used in the practice or testing of the present invention. All publications, patent applications, patents and other references mentioned herein are incorporated by reference in their entirety. The materials, methods, and examples disclosed herein are illustrative only and not intended to be limiting.

The invention will now be described by way of non-limiting example with reference to the following Examples, Tables, experiments, description and claims.

### A. EXPERIMENT

### (a) Conditions Used for Treatment of Green Rooibos Plant Material With Commercial Enzymes

Different commercial enzymes were sourced from Biocatalyst (Pontypridd, Wales) or Novo Nordisk (Bagsvaerd, Denmark) as indicated in Table 1.

TABLE 1
Commercial enzymes and respective enzyme activities.

| Commercial Enzyme | Activities* | Source |
|---|---|---|
| Cellulase 13L | Cellulase 1 500 U/g | Biocatalysts |
| Depol ™ 112L | β-Glucanase 7 000 U/g | Biocatalysts |
| | Xylanase 4 000 U/g | |
| Depol ™ 670L | Cellulase 1 200 U/g | Biocatalysts |
| | Pectinase 800 U/g | |
| | Ferulic acid esterase 7 U/g | |
| Depol ™ 740L | Ferulic acid esterase 36 U/g | Biocatalysts |
| Fructozyme L | Exo-inulinase 2 000 ING/g | Novo Nordisk |
| Glucanase 5XL | β-Glucanase 12 500 U/g | Biocatalysts |
| Laccase L603P | Laccase 112 000 POU/g | Biocatalysts |
| Lactase L107P | Lactase 65 000 U/g | Biocatalysts |
| Pectinex ® Ultra SP-L | Pectinase 26 000 PG/ml | Nova Nordisk |
| PpL Laccase | Laccase 2 500 U/g | Nova Nordisk |
| Suberase | Phenol Oxidase 10 500 PCU/ml | Nova Nordisk |
| Tannase C | Tannase 90 U/ml | Nova Nordisk |
| Tannase P | Tannase 200 U/g | Nova Nordisk |
| Depol ™ 692L | Cellulase 800 U/g | Biocatalysts |
| | Ferulic acid esterase 3 U/g | |
| Ultraflo ® L | β-Glucanase 45 FBG/g | Nova Nordisk |
| Ultrazym P | Proteolytic enzyme 200 000 U/g | Nova Nordisk |

*Activities as defined by manufacturers

For laboratory-scale evaluations, duplicate batches of 100 g dried green tea were treated for 6 hrs at either 40° C. or 50° C. with different concentrations of selected commercial enzymes (Table 2) diluted in Citrate buffer (pH 3.5 or 5.5) to a final volume of 150 ml. The treated samples were subjected to sensorial and visual evaluation, dried in an air tunnel for 3 hrs at 40° C. and analysed for soluble solids (SS), total polyphenols (TP), antioxidants and extract colour.

TABLE 2
Parameters for treatment of dried green tea.

| Enzyme | Dosage* | Temperature (° C.) | pH |
|---|---|---|---|
| Cellulase | 5 | 40 | 5.5 |
| Cellulase 13L | 1; 10 | 40 | 5.5 |
| Depol ™ 112L | 0.25; 2.5 (μl/g tea) | 40 | 5.5 |
| Depol ™ 670L | 20 (μl/g tea) | 40 | 5.5 |
| Depol ™ 740L | 0.1; 1 | 40; 50 | 5.5 |
| Fructozyme | 1; 10 | 40 | 5.5 |
| Glucanase 5XL | 1; 10 | 40; 50 | 5.5 |
| Laccase L603P | 1; 10 | 40 | 5.5 |
| Lactase L107P | 1; 10 | 40 | 5.5 |
| Pectinex ® Ultra SP-L | 1; 260 | 40 | 3.5 |
| PpL Laccase | 1 | 40; 50 | 5.5 |
| Suberase | 2, 20, 1000 | 40 | 5.5 |
| Depol ™ 692L | 10; 100 (μl/g tea) | 40 | 5.5 |
| Ultraflo ® L | 0.009; 0.09; 1 | 40; 50 | 5.5 |

Duplicate batches of 230 g freshly cut green plant material (equivalent to 150 g dried tea) were treated for 1.5-6 hrs at 35° C. to 60° C. with different concentrations of selected commercial enzymes or enzyme cocktails (Table 3) diluted in Citrate buffer (pH 5.5) to a final volume of 100 ml. The treated samples were subjected to sensorial and visual evaluation, dried in an air tunnel for 3 hrs at 40° C. and analysed for soluble solids (SS), total polyphenols (TP), antioxidants and extract colour.

TABLE 3
Parameters for treatment of freshly cut green Rooibos tea.

| Enzyme | Dosage* | Temperature (° C.) | Treatment time (hrs) |
|---|---|---|---|
| Laccase | 1; 10; 50; 100; | 40; 60 | 4 |
| L603P | 500; 1000; 2000 | | |
| PpL Laccase | 1; 10 | 35; 40; 50 | 1.5; 3; 4; 6 |
| Suberase | 10 | 40 | 4 |
| Tannase C | 0.09; 1; 5 | 40 | 4 |
| Tannase P | 0.2; 1; 5 | 40 | 4 |
| Depol ™ 692L | 10 (μl/g tea) | 50 | 3; 6 |
| Ultraflo ® L | 1; 2 | 40; 50 | 3; 6 |
| Ultrazym P | 1; 10 | 40 | 4 |
| Cocktail #3 | 1.5 μl Depol ™ 112L | 40 | 2; 3; 4 |
| | 2.44 μl Depol ™ 692L | | |
| | 3.9 U Pectinex Ultra SP-L | | |
| | 250 U Laccase L603P | | |
| Cocktail #4 | 1.5 μl Depol ™ 112L | 40 | 2; 3; 4 |
| | 2.44 μl Depol ™ 692L | | |
| | 3.9 U Pectinex Ultra SP-L | | |
| | 250 U Laccase L603P | | |
| Cocktail #10 | 2 μl Depol ™ 112L | Fermentation heap | 18 |
| | 1 μl Pectinex Ultra SP-L | (30° C.-38° C.) | |

Commercial-scale evaluations on fresh green tea were carried out at a commercial tea processing facility with equipment and procedures routinely used during commercial tea processing, unless stated otherwise. Two batches of 150 kg freshly cut plant material were treated with #Cocktail 10 (see Table 3 for corresponding enzyme activities) diluted in 10 litres water and sprayed onto the fermentation heap. Another 80 litres water was added with frequent manual turning of the heap, followed by mechanical bruising of the plant material. This process of turning and bruising was repeated three times as per normal practice. Two control heaps of 150 kg freshly cut plant material received 90 litres water and were treated as described above. The heaps were left overnight to “ferment” (ca. 18 hr) during which the temperature in the fermentation heaps increased from ca 30° C. to 38° C. Small samples were collected from each heap and dried in a thin layer on a drying tray; the rest of the heaps were spread open to dry in the sun and collected separately in bulk. The samples were sieved (<10 mesh; >40 mesh) before chemical analysis and sensory evaluation (taste panel A), whilst the bulk samples were subjected to sensory evaluation by an experienced tea taster (B).

### (b) Conditions Used for Analysis of Rooibos Plant Material After Treatment With Commercial Enzymes

Soluble solids from the dried tea were extracted in duplicate by adding 150 ml boiling purified and deionised water to 2 g tea and stirring for 2 min on a magnetic stirrer, whereafter the extract was filtered through filter paper (Whatman nr. 4 or equivalent).

The soluble solid content, expressed as g SS/100 ml tea extract (% SS), was determined gravimetrically in duplicate after 20 ml of the extract was evaporated on a steam bath and dried for 1 hour at 100° C.

Total polyphenol content of the extract, expressed as mg GAE/g tea (TP), was determined in triplicate according to the Folin-Ciacalteu assay of Singleton and Rossi (1965) with gallic acid as standard.

Objective colour measurement of the extract. (L*, a* and b*) was done in triplicate with a Colorgard 2000 system with a TM-M transmission attachment (5 mm path length quartz cell) to the 05 sensor. Readings were done according to the three-dimensional CIEL*a*b*-scale where L* indicates black (−) to white (+) tones; a* indicates green (−) to red (+) tones, and b* indicates blue (−) to yellow (+) tones (Joubert, 1995).

Total antioxidant activity of extracts, expressed as μmol TROLOX/gSS, was determined in duplicate according to the 2,2′-azino-bis(3-ethylbenzothiazoline-6-sulfonic acid) diammonium salt (ABTS) cation radical scavenging method using TROLOX as standard (Re et al., 1999).

Reversed-phase HPLC quantification of specific antioxidants was carried out in duplicate with UV detection at 288 and 255 nm, depending on the chemical structure (Joubert, 1996). Authentic standards were used for quantification.

Statistical analyses were done on the results by comparing data from treatments with that of the respective controls using one-way ANOVA and the Bonferroni post-hoc tests.

### (c) Effect of Treatment With Commercial Enzymes on the Extraction of Colour, Soluble Solids, Total Polyphenols and Antioxidants from Green Rooibos Plant Material

At the conditions indicated in Table 4, Depol™ 670L, Pectinex® Ultra SP-L and Depol™ 692L increased the SS and TP content of the extract by more than 20% and 10%, respectively. Suberase increased release of soluble solids by more than 20% at 1000 U/g tea, whilst also improving the colour development in both the extract and leaves. As shown for Depol™ 692L, an increase in dosage generally resulted in an increase in the extraction of soluble solids, although this tends to have a reduced % TP/SS ratio (lower polyphenol content).

TABLE 4
Effect of treatment with commercial enzymes on yield of % SS, TP and colour from green tea.

| | Dosage | | % SS | TP | | | | | | | |
|---|---|---|---|---|---|---|---|---|---|---|---|
| | (U/g tea or | | (g/100 g | (mg GAE/g | | Colour - Rooibos extract | | | Colour - Rooibos leaves | | |
| Treatment | μl/g) tea | | dry leaves) | tea) | % TP/SS | L* | a* | b* | L* | a* | b* |
| Control - Buffer pH 3.5 | | | 16.45 | 4.76 | 28.95 | 88.35 | 4.74 | 47.40 | 33.31 | 9.49 | 22.60 |
| Control - Buffer pH 5.5 | | | 17.29 | 4.32 | 24.96 | 84.53 | 1.15 | 73.65 | 31.70 | 12.70 | 24.35 |
| Control - Buffer pH 6.5 | | | 18.00 | 4.13 | 22.95 | 82.86 | 1.57 | 79.88 | 31.96 | 13.80 | 24.76 |
| Depol 670L (pH 5.5) | 20 | μl | 21.83 | 4.68 | 21.45 | 85.27 | −2.72 | 64.89 | 32.92 | 11.31 | 25.15 |
| | | | 133 ± 2.02% | 117 ± 4.85% | 88% | 100% | 124% | 94% | 100% | 91% | 101% |
| Pectinex (pH 3.5) | 260 | U | 21.49 | 5.30 | 24.66 | 85.16 | −3.75 | 37.47 | 34.26 | 8.75 | 23.36 |
| | | | 131 ± 2.23% | 111 ± 1.09% | 85% | 96% | 79% | 79% | 103% | 92% | 103% |
| Depol 692L (pH 5.5) | 10 | μl | 20.63 | 4.90 | 23.74 | 84.13 | −1.07 | 77.98 | 29.98 | 12.58 | 22.13 |
| | | | 121 ± 3.25% | 121 ± 2.82% | 100% | 100% | 98% | 100% | 99% | 99% | 98% |
| Depol 692L (pH 5.5) | 100 | μl | 28.27 | 5.80 | 20.49 | 81.49 | −0.40 | 74.32 | 30.41 | 11.74 | 21.78 |
| | | | 166 ± 3.38% | 147 ± 3.13% | 89% | 96% | 34% | 92% | 101% | 92% | 98% |
| PpL Laccase (pH 5.5) | 1 | U | 16.89 | 2.37 | 14.04 | 78.04 | 6.93 | 89.69 | 27.60 | 12.47 | 19.07 |
| | | | 95 ± 3.46% | 78 ± 1.51% | 82% | 93% | −547% | 124% | 87% | 105% | 81% |
| Suberase (pH 5.5) | 1000 | U | 16.91 | Nd | Nd | 76.63 | 7.91 | 73.33 | 31.75 | 10.03 | 17.21 |
| | | | 123 ± 0.37% | | | 88% | −2842% | 240% | 85% | 137% | 91% |

(1) All % are relative to respective controls (data only shown for one example of controls).
(2) Deviations of more than 10% from the respective controls are indicated in bold.
Nd, not determined

HPLC analyses of ten of the most important antioxidants in Rooibos tea extract, showed that treatment with Depol™ 670L at pH 5.5 increased the level of two of the major antioxidants, aspalathin and nothofagin by 38% and 90%, while the flavonoid content of the TP was increased by 21% (Table 5). Treatment with Pectinex Ultra SP-L at pH 3.5 increased the levels of nothofagin and quercetin by 22% and 27%, respectively, while the flavonoid content of the TP was increased by 18%.

TABLE 5
Effect of treatment with commercial enzymes on the release of different antioxidants from green Rooibos tea.

| | % Deviation from control | | | | | | | | | | | | | μmol | μmol |
|---|---|---|---|---|---|---|---|---|---|---|---|---|---|---|---|
| | | | | | | | Isoquer/ | | | | % Tot | % Tot | % | Trolox/g | Trolox/ |
| Enzyme | Asp | Orient | Isoorien | Vitex | Noth | Isovitex | Rutin | Quer | Luteol | Chrys | Flav/SS | Flav/TP | TP/SS | SS | g TP |
| Control - pH | 2.686 | 0.757 | 0.924 | 0.165 | 0.083 | 0.148 | 0.435 | 0.009 | 0.015 | 0.002 | 5.21 | 21.385 | 24.37 | 1408 | 5781 |
| 5.5 | | | | | | | | | | | | | | | |
| Depol 670L pH | 3.696 | 0.573 | 0.638 | 0.133 | 0.158 | 0.130 | 0.129 | 0.011 | 0.011 | 0.002 | 5.47 | 25.781 | 21.44 | 1244 | 5854 |
| 5.5 | | | | | | | | | | | | | | | |
| (20 μl/g tea) | | | | | | | | | | | | | | | |
| | 138% | 76% | 69% | 81% | 190% | 87% | 30% | 119% | 73% | 103% | 105% | 121% | 88% | 88% | 101% |
| Control - pH | 8.115 | 0.919 | 1.156 | 0.163 | 0.387 | 0.169 | 0.172 | 0.006 | 0.003 | 0.003 | 11.09 | 38.360 | 28.97 | 1570 | 5425 |
| 3.5 | | | | | | | | | | | | | | | |
| Pectinex pH | 8.732 | 0.721 | 0.908 | 0.103 | 0.473 | 0.142 | 0.096 | 0.007 | 0.003 | 0.002 | 11.19 | 45.438 | 24.63 | 1300 | 5304 |
| 3.5 | | | | | | | | | | | | | | | |
| (260 U/g tea) | | | | | | | | | | | | | | | |
| | 108% | 78% | 79% | 63% | 122% | 84% | 56% | 127% | 83% | 86% | 101% | 118% | 85% | 83% | 98% |

*Abbreviations for antioxidants: Asp, aspalathin; Orient, orientin; Isoorien, Isoorientin; Vitex, vitexin; Noth, nothofagin, Isovitex, isovitexin; Isoquer/Rutin, Isoquercitrin/Rutin; Quer, quercetin; Luteol, luteolin; Chrys, chrysoeriol.
(1) Results are given as % deviation from the respective controls.
(2) Values in bold indicate statistically significant differences (at 5% level).

Noteworthy was the effect of the pH of the Citrate Buffer used for dilution of the enzymes; treatment at higher pH resulted in an increase in the extraction of soluble solids and colour, but with a concomitant reduction in the TP content (Controls in Table 4). This was also seen with the HPLC analyses (Table 5) where the Citrate Buffer at pH 3.5 extracted higher levels of aspalathin and nothofagin (and higher % Total Flavonoids) than at pH 5.5.

Treatments with PpL Laccase (Table 4) or enzyme Cocktails #3 and #4 (Table 6) led to a significant impact on the extract colour (indicated by decline in L* value and increase in a* and b* values), but also a reduction in the total polyphenol content of the extract. The effect was more profound with increased laccase concentrations (500 U for Cocktail #4 versus 250 U for Cocktail #3) and longer treatment times. Treatment with the two cocktails also had a marked effect on the leaf colour, suggesting that the laccase treatment resulted in the polymerisation of phenols, rendering them insoluble.

TABLE 6
Effect of treatment with commercial enzymes on the yield in % SS, TP, antioxidants and colour from green tea.

| | | | | | Colour - Rooibos | | | Colour - Rooibos | | |
|---|---|---|---|---|---|---|---|---|---|---|
| | % SS (g/100 g | TP (mg | | AOX (μmol | extract | | | leaves | | |
| Treatment | dry leaves) | GAE/g tea) | % TP/SS | Trolox/g SS) | L* | a* | b* | L* | a* | b* |
| Control - pH 5.5 (2 hr) | 18.30 | 3.68 | 20.13 | 1349.77 | 87.55 | −0.34 | 30.53 | 37.66 | 8.61 | 24.65 |
| Control - pH 5.5 (3 hr) | 18.24 | 3.78 | 20.75 | 1412.60 | 87.13 | −0.26 | 30.84 | 36.11 | 9.33 | 24.01 |
| Control - pH 5.5 (4 hr) | 19.53 | 3.93 | 20.11 | 1385.82 | 86.95 | −0.18 | 32.00 | 36.45 | 9.60 | 24.36 |
| Cocktail #3 (2 hr) | 19.51 | 3.24 | 16.60 | 947.97 | 79.13 | 5.55 | 76.55 | 29.69 | 13.58 | 22.55 |
| | 107 ± 3.71% | 88 ± 3.82% | 82% | 70 ± 1.39% | 90% | −1633% | 251% | 79% | 158% | 91% |
| Cocktail #3 (3 hr) | 19.85 | 3.16 | 15.91 | 853.06 | 77.93 | 6.82 | 79.14 | 28.04 | 13.66 | 21.35 |
| | 109 ± 2.82% | 84 ± 2.37% | 77% | 60 ± 1.46% | 89% | −2621% | 257% | 78% | 146% | 89% |
| Cocktail #3 (4 hr) | 20.77 | 3.36 | 16.17 | 832.92 | 77.26 | 8.13 | 81.88 | 28.34 | 14.22 | 21.33 |
| | 106 ± 1.00% | 85 ± 1.99% | 80% | 60 ± 1.40% | 89% | −4515% | 256% | 78% | 148% | 88% |
| Cocktail #4 (2 hr) | 19.14 | 2.87 | 14.98 | 665.26 | 74.67 | 9.09 | 80.07 | 25.30 | 12.98 | 19.60 |
| | 105 ± 0.90% | 78 ± 1.35% | 74% | 49 ± 1.47% | 85% | −2675% | 262% | 67% | 151% | 80% |
| Cocktail #4 (3 hr) | 18.74 | 2.85 | 15.23 | 805.16 | 75.59 | 7.25 | 78.87 | 26.45 | 12.78 | 19.95 |
| | 103 ± 0.06% | 75 ± 1.12% | 73% | 57 ± 2.13% | 87% | −2789% | 256% | 73% | 137% | 83% |
| Cocktail #4 (4 hr) | 19.80 | 2.63 | 13.29 | 668.98 | 75.12 | 8.33 | 78.98 | 24.07 | 13.33 | 19.43 |
| | 101 ± 3.17% | 67 ± 2.10% | 66% | 48 ± 1.16% | 86% | −4628% | 247% | 66% | 139% | 80% |

(1) Results are given as % deviation from the respective controls.
(2) Deviations of more than 10% from the respective controls are indicated in bold.

Industrial-scale treatment of freshly cut green tea with Cocktail #10 (Depol 112L+Pectinex Ultra SP-L) increased the yield in soluble solids and TP by 32% and 20%, relative to the water control (Table 7). Although the % TP/SS ratio is slightly lower at 91%, the TP and antioxidant content of the extract exceeds the benchmark of both 20 mg GAE/100 g SS (% TP/SS) and 1 200 μmol Trolox/g SS by 47%. The ‘loss’ in % TP/SS ratio can be ascribed to the extraction of soluble solids with a lower antioxidant content, but it is also possible that the maceration of the plant material increase the exposure of the polyphenols to air.

TABLE 7
Effect of commercial enzymes on yield in % SS, TP and
antioxidants from green tea

| | | Yield | mg | TP | umol | umol |
|---|---|---|---|---|---|---|
| | | (% | GAE/100 ml | as % | Trolox/ | Trolox/ |
| Enzyme | % SS | of tea) | extract | of SS | g SS | g TP |
| Control - Water | 0.153 | 11.48 | 49.9 | 32.7 | 1986 | 6528 |
| Cocktail #10 | 0.203 | 15.21 | 59.7 | 29.6 | 1769 | 6011 |
| | 133% | 132% | 120% | 91% | 89% | 92% |

Results are given as the means of duplicate or triplicate measurements, expressed as % relative to respective controls.
Quality parameters: 20 mg GAE/100 g SS [% TP/SS], 1200 μmol Trolox/g SS

Industrial-scale treatment with Cocktail #10 did not improve the colour of the tea extract or leaves (Table 8), and resulted in low scores for the sensorial evaluations (Table 9). The underfermented character was also observed in other tea process via conventional fermentation (see Table 8, “Other tea”) and could be ascribed to the low temperature in the fermentation heaps due to cold weather during the evaluation period (30-38° C., as apposed to 40° C. routinely found in the heaps and used for laboratory evaluations).

TABLE 8
Colour determinants after treatment of fresh green tea with enzyme
cocktails

| | Extract colour | | | Leave colour | | |
|---|---|---|---|---|---|---|
| Enzyme | L* | a* | b* | L* | a* | b* |
| Control - Water | 72.70 | 4.21 | 61.95 | 29.89 | 13.41 | 22.46 |
| Cocktail #10 | 74.67 | 1.61 | 59.64 | 31.43 | 12.82 | 21.98 |
| | 103% | 38% | 96% | 105% | 96 | 98 |

TABLE 9
Sensorial evaluation of tea made by infusion after enzyme treatment
A. Rooibos taste panel of five members

| | | Cloudy/ | | | |
|---|---|---|---|---|---|
| Sample | Appearance | Clear | Taste | Comments | Grading |
| Control | 6 | 3 | 2 | Cloudy, Taste | 38% = Class D |
| | | | | unacceptable | |
| Cocktail | 6 | 3 | 2 | Taste | 38% = Class D |
| #10 | | | | unacceptable | |

B. Expert Rooibos tea taster

| Sample | Aroma | Taste | Colour | Comments | Grading |
|---|---|---|---|---|---|
| Control | 7 | 7 | 7 | Darker colour, | Pass |
| | | | | yet dull | |
| Cocktail | 7 | 7 | 6 | Dull, light in colour | Taste Pass, |
| #10 | | | | | Colour not |
| | | | | | passed |
| Other tea | 6 | 5 | 8 | Bitter, green taste | Pass |

### (d) Conditions Used for Treatment of Fermented Rooibos Plant Material With Commercial Enzymes

For laboratory-scale treatments, batches of 150 g dried fermented tea were treated in duplicate at 40° C. for 2 hrs with different concentrations of selected commercial enzymes (Table 10) diluted in Citrate Buffer (pH 5.5) to a final volume of 225 ml. Duplicate batches of 150 g fermented tea (waste material with high stalk content) were treated with 150 ml Citrate buffer (pH 5.5) containing Cocktail #5 to #12 at 40° C. for 2 hrs. The tea was then dried in an air tunnel for 3 hrs at 40° C. and analysed as described in Section A (b).

TABLE 10
Commercial enzymes and synthetic cocktails used for treatment of
fermented Rooibos tea for 2 hrs at 40° C., pH 5.5

| Enzyme | |
|---|---|
| cocktail | Dosage |
| Depol ™ 670L | 2 μl or 20 μl/g tea |
| Pectinex Ultra | 26 U or 260 U/g tea |
| SP-L | |
| Depol ™ 692L | 1 μl or 10 μl/g |
| Ultraflo ® L | 0.01 U or 0.1 U/g tea |
| Depol ™ 740L | 0.1 μl or 1 μl/g tea |
| Depol ™ 112L | 1 μl or 10 μl/g tea |
| Cocktail #1 | 1.5 μl/g tea Depol ™ 112L, 1.62 μl/g tea Depol ™ 670L, |
| | 3.9 U/g tea Pectinex Ultra SP-L, 1002 U Laccase 603P |
| Cocktail #2 | 1.5 μl/g tea Depol ™ 112L, 2.44 μl/g tea Depol ™ 692L, |
| | 3.9 U/g tea Pectinex Ultra SP-L, 1002 U Laccase 603P |
| Cocktail #5 | 1.5 μl/g tea Depol ™ 112L, 1.62 μl/g tea Depol ™ 670L, |
| | 3.9 U/g tea Pectinex Ultra SP-L |
| Cocktail #6 | 1.5 μl/g tea Depol ™ 112L, 2.44 μl/g tea Depol ™ 692L, |
| | 3.9 U/g tea Pectinex Ultra SP-L |
| Cocktail #7 | 2 μl/g tea Depol ™ 670L, 0.1 U/g tea Depol ™ |
| | 740L |
| Cocktail #8 | 2 μl/g tea Depol ™ 670L, 1 μl/g tea Depol ™ 112L |
| Cocktail #9 | 26 U/g tea Pectinex Ultra SP-L, 0.1 U/g tea Depol ™ |
| | 740L |
| Cocktail #10 | 26 U/g tea Pectinex Ultra SP-L, 1 μl/g tea Depol ™ 112L |
| Cocktail #11 | 1 μl/g tea Depol ™ 692L, 0.1 U/g tea Depol ™ 740L |
| Cocktail #12 | 1 μl/g tea Depol ™ 692L, 1 μl/g tea Depol ™ 112L |

For small-scale simulated industrial treatments of fermented tea, duplicate batches of 150 g fermented tea (waste material with high stalk content) were treated with 150 ml dH₂O containing Pectinex Ultra SP-L (26 U or 260 U/g tea), Depol™ 670L (2 μl or 20 μl/g tea), Depol™ 692L (1 μl or 10 μl/g tea), Depol™ 112L (1 μl/g tea) or Depol™ 740L (0.1 U/g tea) at 40° C. for 2 hrs and dried in an air tunnel for 3.5 hrs at 40° C. The batches were pooled and samples of 100 g dried tea were extracted with 1000 ml of deionised water at 90-93° C. for 30 min, where after it was decanted and filtered through Whatman #4 filter paper. The filtrate was cooled to room temperature and cleaned up by filtration through a 0.8 μm pore size filter (AP15).

In industrial evaluations, duplicate batches of 80 kg fermented Rooibos waste (coarse stems and leaves) were treated in a rotary stainless drum for 2 h at a temperature of ca 37° C. The control treatments received 80 litres water, while the enzyme treatments received Cocktail #10 (see Table 10 for dosage and corresponding activities) diluted in 20 litre water, plus another 60 litres water. After treatment, samples were taken to determine the moisture content and 3 kg of the moistened tea was extracted with 15 litres water at ca 90° C. for 30 min. The plant material and extract were separated using a fine mesh cloth and ˜5 litre of the extract was subjected to microfiltration using a Pellicon Cassette and Filter cross-flow ultrafiltration device system and a 0.22 μm membrane. The filtered extract was analysed for SS, TP and antioxidant content as previously described.

### (e) Effect on the Release of Soluble Solids, Total Polyphenols and Antioxidants from Fermented Rooibos Tea When Treated With Commercial Enzymes

For laboratory-scale treatments, Depol™ 670L, Depol™ 692L and Pectinex® Ultra SP-L increased the release in SS by more than 10% when applied at the dosages indicated in Table 11. As shown for Pectinex, higher enzyme dosages tend to be more effective for the release of soluble solids, but coincided with a reduction in the TP and antioxidant content. Depol™ 112L and Depol™ 740L increased the antioxidant content of the extract with no significant increase in the yield in SS, suggesting the extraction of additional polyphenols with high antioxidant activity (i.e. “active compounds”), especially at the lower enzyme dosages.

TABLE 11
Effect of laboratory-scale treatments with commercial enzymes on the yield
of % SS, TP and antioxidants from fermented tea.

| | Dosage (U/g | | % SS (g/100 g | TP (mg GAE/g | | AOX (μmol |
|---|---|---|---|---|---|---|
| Treatment | tea or μl/g tea) | | dry leaves) | tea) | % TP/SS | Trolox/g SS) |
| Control - pH 5.5 | | | 11.50 | 3.13 | 25.69 | 1730.50 |
| Depol 670L | 20 | μl | 16.62 | 3.11 | 22.05 | 1476.14 |
| | | | 144 ± 3.01% | 99 ± 3.94% | 86% | 85 ± 3.26% |
| Depol 692L | 1 | μl | 12.82 | 3.19 | 26.36 | 1728.29 |
| | | | 111 ± 3.76% | 102 ± 3.53% | 103% | 100 ± 3.57% |
| Depol 692L | 10 | μl | 12.91 | 3.31 | 24.90 | 1558.62 |
| | | | 112 ± 1.15% | 106 ± 2.38% | 97% | 90 ± 4.95% |
| Pectinex | 26 | U | 13.91 | 3.29 | 22.72 | 1511.74 |
| | | | 121 ± 2.35% | 105 ± 1.02% | 88% | 87 ± 5.37% |
| Pectinex | 260 | U | 16.23 | 3.37 | 22.39 | 1405.30 |
| | | | 141 ± 2.55% | 108 ± 4.18% | 87% | 81 ± 2.53% |
| Control - pH 5.5 | | | 12.60 | 2.99 | 24.83 | 1343.50 |
| Depol 112L | 1 | μl | 11.52 | 3.05 | 26.27 | 1708.61 |
| | | | 91 ± 5.80% | 102 ± 3.98% | 106% | 127 ± 2.95% |
| Depol 112L | 10 | μl | 11.47 | 3.05 | 26.07 | 1598.34 |
| | | | 91 ± 5.02% | 102 ± 2.04% | 105% | 119 ± 5.75% |
| Depol 740L | 0.1 | U | 11.78 | 3.18 | 25.58 | 1860.88 |
| | | | 94 ± 4.00% | 106 ± 5.19% | 103% | 139 ± 5.20% |
| Depol 740L | 1 | U | 13.08 | 3.12 | 23.67 | 1530.47 |
| | | | 104 ± 3.33% | 104 ± 3.74% | 95% | 114 ± 4.57% |

(1) Results are given as % deviation from the respective controls.
(2) Deviations of more than 10% from the respective controls are indicated in bold.

As shown in Table 12, enzyme Cocktails #1 and #2 decreased the SS, TP and antioxidant content of the extract, probably due to the high laccase concentrations. Cocktails #6, #7 and #8 all increased the yield in SS from fermented tea while Cocktail #10 increased both the SS and TP content. These four cocktails all contain different combinations of pectinase, xylanase, cellulase, β-glucanase and/or ferulic acid esterase (FAE) activities. Cocktails #11 and #12 have a similar composition than #7 and #8 (Table 10), but with a 3-fold lower concentration of cellulase.

TABLE 12
Effect of treatment with synthetic enzyme cocktails on the yield of %
SS and TP from fermented tea.

| | % SS (g/100 g dry | | |
|---|---|---|---|
| Treatment | leaves) | TP (mg GAE/g tea) | % TP/SS |
| Control - pH 5.5 | 11.36 | 3.01 | 26.42 |
| Cocktail #1 | 9.99 | 1.13 | 11.32 |
| | 88 ± 2.07% | 38 ± 0.60% | 43% |
| Cocktail #2 | 9.53 | 1.22 | 12.83 |
| | 84 ± 2.11% | 41 ± 0.45% | 49% |
| Control - pH 5.5 | 10.36 | 3.04 | 26.44 |
| Cocktail #5 | 11.31 | 2.98 | 26.18 |
| | 109 ± 5.88% | 98 ± 0.63% | 99% |
| Cocktail #6 | 11.77 | 2.97 | 23.12 |
| | 114 ± 3.52% | 98 ± 0.82% | 87% |
| Cocktail #7 | 11.58 | 3.05 | 25.82 |
| | 112 ± 3.82% | 100 ± 1.50% | 98% |
| Cocktail #8 | 11.70 | 3.16 | 26.91 |
| | 113 ± 4.40% | 104 ± 4.50% | 102% |
| Control - pH 5.5 | 11.51 | 3.41 | 29.59 |
| Cocktail #9 | 11.38 | 3.12 | 27.43 |
| | 99 ± 4.63% | 92 ± 3.77% | 93% |
| Cocktail #10 | 12.76 | 3.88 | 30.38 |
| | 111 ± 2.60% | 114 ± 1.74% | 103% |
| Cocktail #11 | 11.80 | 3.20 | 27.17 |
| | 103 ± 2.68% | 94 ± 5.52% | 92% |
| Cocktail #12 | 11.71 | 3.30 | 28.21 |
| | 102 ± 3.63% | 97 ± 0.29% | 95% |

(1) Results are given as % deviation from the respective controls.
(2) Deviations of more than 10% from the respective controls are indicated in bold.

Similar trends were observed in the industrial simulations (Table 13) where Depol™ 670L, Pectinex® Ultra SP-L and Depol™ 692L increased the yield in SS by more than 10% with the higher dosages being more effective. Treatments with Depol™ 112L and Depol™ 740L were also more effective than the laboratory-scale treatments with an increase of 10% in the TP content for both treatments.

TABLE 13
Effect of treatment with commercial enzymes on the yield
of % SS and TP from fermented tea in industrial simulations
(only data for AP 15 filtrate are shown).

| | Dosage | | % SS (g/100 | TP (mg | |
|---|---|---|---|---|---|
| | (U/g tea or | | g dry | GAE/g | % |
| Treatment | μl/g tea) | | leaves) | tea) | TP/SS |
| Control - dH₂O | | | 12.46 | 3.82 | 30.71 |
| Depol 670L | 2 | μl/g | 14.54 | 3.88 | 26.67 |
| | | | 117 ± 1.00% | 102 ± 2.73% | 87% |
| Depol 670L | 20 | μl/g | 15.65 | 3.71 | 23.69 |
| | | | 126 ± 0.4% | 97 ± 2.29% | 77% |
| Depol 692L | 1 | μl/g | 13.94 | 4.05 | 29.03 |
| | | | 112 ± 0.52% | 106 ± 1.25% | 95% |
| Depol 692L | 10 | μl/g | 15.39 | 3.98 | 25.89 |
| | | | 123 ± 1.94% | 104 ± 3.42% | 84% |
| Pectinex | 26 | U | 14.00 | 3.92 | 27.98 |
| | | | 112 ± 0.74% | 103 ± 1.14% | 91% |
| Pectinex | 260 | U | 15.53 | 3.64 | 23.46 |
| | | | 125 ± 1.65% | 95 ± 1.23% | 76% |
| Control - dH₂O | | | 13.92 | 3.89 | 27.97 |
| Depol 112L | 1 | μl/g | 14.52 | 4.29 | 29.56 |
| | | | 104 ± 0.54% | 110 ± 3.08% | 106% |
| Depol 740L | 0.1 | U | 14.30 | 4.26 | 29.78 |
| | | | 103 ± 0.17% | 110 ± 2.66% | 106% |

(1) Results are given as % deviation from the respective controls.
(2) Deviations of more than 10% from the respective controls are indicated in bold.

Industrial evaluations were done with a combination of Pectinex® Ultra SP-L and Depol 112L (Cocktail #10) on ‘waste’ fermented tea material with high stalk content. The cocktail increased the yield in SS by 14% in the final filtrate (Table 14), but this coincided with a decrease of 5% in the TP content, therefore a reduction of more than 15% in the % TP/SS and μmol Trolox/g SS ratios. The extract yield (expressed as % of tea) for the control was similar to the yield generally obtained by Afriplex in routine extractions. The enzyme treatment increased this yield by 13%, while the TP and antioxidant content is very close to the benchmark of 20 mg GAE/100 g SS and 1200 μmol Trolox/g SS. It is most likely that the continuous pumping and mixing of the wet material to ensure a consistent temperature of 90-93° C. enhanced the exposure to air, resulting in a greater loss in antioxidants.

TABLE 14
Effect of commercial enzymes on yield in % SS, TP and antioxidants from
fermented tea in industrial evaluations

| | | | | | | AOX | AOX |
|---|---|---|---|---|---|---|---|
| | | | Extract | mg | | (μmol | (μmol |
| | | | yield (% | GAE/100 ml | TP as | Trolox)/g | Trolox)/g |
| Enzyme | Filtrate | % SS | of tea) | extract | % of SS | SS | TP |
| Control - Water | UF (0.22 μm) | 0.607 | 6.22 | 151.6 | 24.9 | 1469 | 6429 |
| Cocktail #10 | UF (0.22 μm) | 0.692 | 7.04 | 143.5 | 20.6 | 1192 | 5808 |
| | | 114% | 113% | 95% | 83% | 81% | 90% |

Results are given as the means of duplicate or triplicate measurements, expressed as % relative to respective controls.
Quality parameters: 20 mg GAE/100 g SS [% TP/SS], 1200 μmol Trolox/g SS

### (f) Conditions Used for Treatment of Spent Rooibos Plant Material With Commercial Enzymes

For laboratory-scale treatments, batches of 50 g dried spent tea were treated in duplicate with enzymes (Table 15) diluted in 100 ml citrate buffer (pH 3.5 to pH 6.5). The tea was treated for 1 or 6 hrs at 40° C. followed by drying in an oven for 2 days at 50° C. Enzyme dosages were calculated as U/g tea or where the commercial enzyme product consisted of more than one enzyme, as μl/g tea.

TABLE 15
Parameters for treatment of spent tea.

| | | Treatment time | |
|---|---|---|---|
| Enzyme | Dosage* | (hrs) | pH |
| Cellulase 13L | 15; 30 | 6 | 5.5 |
| Depol ™ 112L | 10; 20 (μl/g tea) | 6 | 5.5 |
| Depol ™ 670L | 2; 20; 200 (μl/g tea) | 1 | 4.5 |
| Depol ™ 740L | 0.1; 1; 10 | 1 | 4.5 |
| Glucanase 5XL | 1; 10 | 6 | 5.5 |
| Laccase L603P | 100; 1000 | 6 | 5.5 |
| Lactase L107P | 1; 10 | 6 | 5.5 |
| Pectinex ® Ultra SP-L | 260 | 1 | 3.5 |
| PpL Laccase | 1 | 1 | 4.5 |
| Suberase | 2 | 1 | 4.5 |
| Depol ™ 692L | 5; 10 (μl/g tea) | 6 | 5.5 |
| Ultraflo ® L | 0.009; 1 | 1 | 6.5 |

*Dosage is defined as U/g tea unless stated otherwise

### (g) Effect on the Release of Soluble Solids, Total Polyphenols and Antioxidants from Spent Rooibos Tea When Treated With Commercial Enzymes

At the dosages indicated in Table 16, Depol™ 670L, Depol™ 740L, Ultraflo® L, Pectinex® Ultra SP-L, Depol™ 692L, Depol™ 112L and Cellulase 13L all released more than 10% additional SS from spent tea, while Lactase increased the yield in TP at 10 U/g tea. At increased dosages, Depol™ 740L and Depol™ 670L showed significant increases in the release of SS (more than two-fold). All the laccases decreased the % SS and TP content significantly. Wherever there was a strong increase in the SS released from the spent tea, the TP/% SS ratio was reduced dramatically, suggesting the extraction of “inactive” compounds, i.e. non-phenolic components with little antioxidant activity.

TABLE 16
Effect of treatment with commercial enzymes on the yield of % SS and TP
from spent tea.

| | Dosage (U/g tea | | % SS (g/100 g dry | | |
|---|---|---|---|---|---|
| Treatment | or μl/g tea) | | leaves) | TP (mg GAE/g tea) | % TP/SS |
| Control - pH 4.5 | | | 8.72 | 1.75 | 20.06 |
| Depol 670L | 2 | μl | 14.56 | 1.81 | 12.45 |
| | | | 167 ± 5.06% | 104 ± 3.75% | 62% |
| Depol 740L | 1 | U | 10.27 | 1.67 | 16.24 |
| | | | 118 ± 4.24% | 95 ± 2.52% | 81% |
| Control - pH 4.5 | | | 8.50 | 1.84 | 21.68 |
| Depol 670L | 200 | μl | 28.27 | 1.83 | 6.50 |
| | | | 332 ± 1.84% | 99 ± 4.10% | 30% |
| Depol 740L | 10 | U | 21.35 | 1.59 | 7.46 |
| | | | 251 ± 3.80% | 86 ± 5.20% | 34% |
| Control - pH 3.5 | | | 7.77 | 1.86 | 23.95 |
| Control - pH 6.5 | | | 9.94 | 2.25 | 22.67 |
| Pectinex (pH 3.5) | 260 | U | 16.56 | 1.49 | 9.03 |
| | | | 213 ± 2.05% | 80 ± 5.65% | 38% |
| Ultraflo (pH 6.5) | 0.009 | U | 11.09 | 2.31 | 20.81 |
| | | | 112 ± 4.38% | 103 ± 5.38% | 92% |
| Control - pH 5.5 | | | 8.79 | 1.93 | 22.0 |
| Depol 692L | 5 | μl | 17.74 | 1.86 | 10.53 |
| | | | 202 ± 5.86% | 97 ± 2.53% | 48% |
| Lactase | 10 | U | 9.17 | 2.14 | 23.33 |
| | | | 104 ± 6.87% | 111 ± 1.96% | 106% |
| Control - pH 5.5 | | | 8.98 | 1.87 | 20.8 |
| Cellulase 13L | 15 | U | 11.88 | 1.96 | 16.49 |
| | | | 132 ± 3.64% | 105 ± 3.98% | 79% |
| Depol 112L | 10 | μl | 12.17 | 1.78 | 14.63 |
| | | | 135 ± 1.82% | 95 ± 2.16% | 70% |

(1) Results are given as % deviation from the respective controls.
(2) Deviations of more than 10% from the respective controls are indicated in bold.

### (h) Fungal Strains Used

Fungal strains used in this study (Table 17) represent a phylogenetically diverse group of fungi including ascomycetous and basidiomycetous groups from the culture collection of the Department of Microbiology at Stellenbosch University, South Africa, or the American Type Culture Collection, Rockville, Md., USA. The other fungal strains listed in Table 17 were isolated from either spent Rooibos tea or different brands of commercial Rooibos tea bags. Approximately 1 g of Rooibos tea was wet with sterile dH₂O in a petri dish and incubated at 30° C. for 3 to 4 days. Individual colonies were transferred to malt extract agar (MEA) plates and incubated for 3 to 4 days at 30° C. This procedure was repeated two to three times to isolate pure cultures that were further identified using a combination of morphological and molecular techniques.

TABLE 17
Source and identity of fungal strains used in this study

| Isolate | | |
|---|---|---|
| number | Organisms | Source |
| DSM 2344 | Aspergillus aculeatus | German Collection of Microorganisms and Cell |
| | | Cultures |
| NRRL 3135/ATCC | Aspergillus ficuum | ARS Culture Collection, National Center for |
| 66876 | | Agricultural Utilisation Research, U.S Department |
| | | of Agriculture, Rockville, Maryland, USA, American |
| | | Type Culture Collection |
| ABO 511 | Aspergillus japonicus | Department Microbiology, Stellenbosch University |
| ATCC 10864 | Aspergillus niger | American Type Culture Collection |
| ATCC 52430 | Aspergillus terreus | American Type Culture Collection |
| ABO 287 | Lentinula edodes | Department Microbiology, Stellenbosch University |
| SAM 3 | Penicillium candidum | Rhoda Foods, France |
| ABO 286 | Pleurotus citzinopileatus | Department Microbiology, Stellenbosch University |
| ABO 283 | Pleurotus djamor | Department Microbiology, Stellenbosch University |
| ABO 280 | Pleurotus ostreatus var. | Department Microbiology, Stellenbosch University |
| | florida | |
| RUT C30 | Trichoderma reesei | Department Microbiology, Stellenbosch University |
| MP1 | Rhizopus oryzae | Isolated from spent tea |
| MP3 | Rhizomucor pushillus | Isolated from green tea |
| MP6 | Neurospora sitophila | Isolated from spent tea |
| MP7 | Paecilomyces variotti | Isolated from commercial tea bags |
| MP8 | Aspergillus tubingensis | Isolated from green tea |

The fungal strains mentioned in the Examples and Tables are kept and maintained at the University of Stellenbosch, Department of Microbiology, Private Bag XI, Matieland 7602, South Africa (contact person: Prof. A Botha, Tel. (021) 808 5851, Fax. (021) 808 5846, e-mail abo@sun.ac.za) and are readily identified by the fungal species and isolate numbers as indicated in Table 17. Samples of these fungal strains will be made available upon request on the same basis and conditions as the per the Budapest treaty.

### (i) Identification of Fungal Strains Isolated from Rooibos Plant Material

The fungal isolates were identified based on the DNA sequence of their ITS regions. Genomic DNA was extracted based on the protocol of Raeder and Broda (1985). Polymerase chain reactions (PCR) were carried out with Expand™ High Fidelity DNA Polymerase (Roche, Germany) in a Perkin Elmer 2 400 Thermal Cycler. Primers ITS 4 (5′-TCC TCC GCT TAT TGA TAT GC-3′) and ITS 5 (5′-GGA AGT AAA AGT CGT AAC AAG-3′), obtained from Roche (Germany) (White et al., 1990), or universal primers F63 (5′-GCA TAT CAA TAA GCG GAG GAA AAG-3′) and LR3 (5′-GGT CCG TGT TTC AAG ACG-3′) were used to amplify the conserved ITS region (Fell et al., 2000). The PCR products were purified using the GFX PCR DNA and Gel Band Purification Kit (Amersham Biosciences) and sequenced using a Perkin Elmer ABI PRISM™ genetic sequencer, Model 3100 (Version 3.7). The fungal isolates were identified by comparing the sequencing results with known sequences using the BLAST software (National Center for Biotechnology Information, www.ncbi.nlm.nlh.gov./blast).

Morphological criteria were employed to confirm the identity of the new isolates and strains from the culture collection. For this purpose, the descriptions of Domsch et al. (1980), Shipper (1973, 1975, 1976,1978, 1984) and Klich (2002) were used.

### (j) Culture Conditions for Enzyme Production by Fungal Strains

Lentinula edodes ABO 287 was maintained on 2.3% agar plates with MYPG medium containing 1% malt extract (Sigma), 0.2% yeast extract (Merck), 0.2% tryptone peptone (Merck), 1% glucose (Merck), 0.2% KH₂PO₄ (Sigma), 0.1% MgSO₄.7H₂O (Sigma), 0.1% L (+)-asparagine (Merck) and 0.1% thiamine (Merck), and incubated at 25° C. for 21 days. The other strains were maintained by periodic transfer to malt extract agar (MEA) (Sigma) plates, incubated for 5 days at 30° C. (or 25° C. for the Pleurotus spp.) and stored at 4° C.

For small-scale cultures, all the fungal strains were cultivated in 200 ml liquid potato dextrose medium (containing infusions of potatoes and glucose) (Sigma) with 5% citrate buffer (pH 5) in 1 litre cotton-plugged Erlenmeyer flasks. Spores were harvested in 100 ml 0.85% sterile sodium chloride, using either 0.1% or 0.01% (v/v) Tween 80 (Merck) or 0.1% or 0.01% Triton X-100 (BDH Chemicals Ltd), and inoculated into 200 ml medium at an initial concentration of 2×10⁷ spores/ml for the spore-forming fungi, or with five mycelial covered agar blocks (6 mm diameter) for non-spore forming fungi. The flasks were incubated on a shaker at 125 rpm at 30° C. for 4 to 5 days or at 25° C. for 21 days in the case of L. edodes. After incubation, the biomass was collected via centrifugation (12,000×g for 20 min) and the supernatant used as is or concentrated ten-fold through the Minitan cross-flow ultrafiltration device (Millipore Corporation, Bedford, Mass., USA).

For large-scale cultures, Lentinula edodes ABO 287, A. niger ATCC 10864, P. ostreatus var. florida ABO 280, P. djamor ABO 283 and the R. oryzae strain isolated from spent tea were cultivated in Erlenmeyer flasks containing either 3 litre YP medium plus 1% wheat straw or potato dextrose broth buffered with 0.05 M citrate buffer (pH 5). Inoculation and incubation was done as described above. The supernatant was collected via centrifugation (12,000×g for 20 min) and concentrated ten-fold with the Pellicon Casette and Filter cross-flow ultrafiltration device with a 5 kDa cut-off membrane. DNS liquid enzyme assays were performed on the concentrated and unconcentrated fungal cocktails to quantify the levels of enzyme activity as described above.

### (k) Method for Determining Enzyme Activities in Fungal Strains

The supernatant from each culture (as is or concentrated ten-fold) was used to quantify endoglucanase, xylanase and pectinase activities in the broth according to the method of Bailey et al. (1992). The xylanase activity was measured using 1% birchwood xylan (Sigma) prepared in citrate buffer (0.05 M, pH 6.0) as substrate with 0.01 M D-xylose (Sigma) as standard. For endoglucanase and pectinase activity, 1% carboxymethylcellulose (Sigma) and 0.1% polygalacturonic acid (Fluka, BioChemika), prepared in 0.05 M citrate buffer (pH 5.0), were used as substrates with 0.01 M D-glucose (Merck) as standard. A reaction time of 5 min were allowed before DNS solution was added. One unit of enzyme activity was defined as the amount of enzyme that released 1 μmol xylose or glucose equivalent per ml per min under the assay conditions. Reducing sugars were determined with the dinitrosalicyclic acid (DNS) method done according to Miller (1959).

β-xylosidase activity was determined by using a combination of the methods described by Kersters-Hilderson (1982) and Poutanen and Puls (1988), which measures the amount of p-nitrophenol released from p-nitrophenyl-β-D-xylopyranoside (pNPX) (Sigma). Esterase and glucosidase activities were measured similarly using p-nitrophenyl β-D-Glucopyranoside (pNPG) (Sigma) and p-nitrophenyl acetate (pNPA) (Sigma) as substrates. One unit of enzymatic activity was defined as the amount of enzyme that released 1 μmol of p-nitrophenol per minute under the assay conditions.

Laccase activity was determined according to the method of Jönsson et al. (1997), using ABTS as substrate. The formation of the cation radical was detected by measuring the increase in absorbance at 420 nm (ε₄₂₀=36 000 M⁻¹ cm⁻¹). One unit of laccase activity was defined as the amount of enzyme that catalysed the oxidation of 1 μmol ABTS in a 100 μl reaction mixture for 1 min at 30° C.

The values given for each experiment are the means of at least three treatment replications. Enzyme and substrate controls were routinely included and all enzyme preparations were appropriately diluted for the determination of activity in the presence of a negligible background reducing sugar concentration.

### (l) Enzyme Activities in Fungal Strains

For the small-scale cultures, the A. japonicus, L. edodes and P. ostreatus var. florida strains had relatively high levels of xylanase, endoglucanase and pectinase activity (Table 18), with A. japonicus also showing higher levels of glucosidase and xylosidase activity than the other strains.

TABLE 18
Enzyme activities in the supernatant from selected fungal strains
prepared in potato dextrose medium.

| | Activity (IU/ml) | | | Activity (×10⁻³ IU/ml) | | |
|---|---|---|---|---|---|---|
| Fungal strain | Xylanase | Endoglucanas | Pectinase | Esterase | Glucosidase | Xylosidase |
| A. japonicus | 20.5 | 22.4 | 22.3 | 0.05 | 4.14 | 21.30 |
| L. edodes | 21.6 | 18.0 | 29.0 | 0.12 | 0.00 | 0.06 |
| P. ostreatus | 20.7 | 29.6 | 26.7 | 0.72 | 0.06 | 0.18 |
| var. florida | | | | | | |

For large-scale cultures prepared in YP-wheat straw medium, the highest level of endoglucanase and xylanase activities were obtained with the enzyme extracts from the concentrated extract of A. niger (Table 19), which also had a relatively high laccase activity.

TABLE 19
Quantitative and qualitative analysis of enzymes in
fungal extracts prepared in YP-wheat straw medium
(as is or ten-fold concentrated). Values given show the
means of duplicate or triplicate measurements on-treatments.

| | Activity (IU/ml) | | | |
|---|---|---|---|---|
| Cocktail | Xylanase | Endoglucanase | Pectinase | Laccase |
| A. niger | 25.4 | 6.1 | 1.0 | 75.6 |
| A. niger (10x) | 183.1 | 7.3 | 1.7 | 570.3 |
| R. oryzae | 1.0 | 0.2 | 0.6 | 129.0 |
| R. oryzae (10x) | 4.0 | 1.3 | 2.6 | 667.8 |
| L. edodes | 2.7 | 1.3 | 0.9 | 102.8 |
| L. edodes (10x) | 4.1 | 1.2 | 3.3 | 176.1 |
| P. ostreatus | 8.8 | 0.7 | 1.0 | 153.7 |
| var. florida | | | | |
| P. ostreatus | 14.0 | 3.9 | 1.2 | 568.9 |
| var. florida (10x) | | | | |
| P. djamor | 1.3 | 1.2 | 1.4 | 180.1 |
| P. djamor (10x) | 9.6 | 4.6 | 2.2 | 594.6 |

### (m) Conditions Used for Treatment of Green, Fermented or Spent Tea With Fungal Cocktails

For small-scale cultures, batches of 100 g green or spent tea were treated in duplicate with 150 ml of the fungal supernatant (as is or ten-fold concentrated) prepared in potato dextrose medium, either as is or ten-fold concentrated. The tea was treated at 40° C. for 6 hours, evaluated for aroma development, dried in an air tunnel for 3 hours at 50° C. (green tea) or 2 days at 50° C. (spent tea), and analysed as described in Section A (b).

For large-scale cultures, duplicate batches of 100 g dried green or fermented Rooibos tea (waste material with high stalk content) were treated with 150 ml of the unconcentrated and concentrated extracts of R. oryzae and L. edodes prepared in 3 litres of YP-wheat straw or potato dextrose medium. The tea was treated at 40° C. for 2 hours (fermented tea) or 6 hours (green tea), dried in an air tunnel for 3 hours at 40° C. and further analysed as described in Section A(b).

### (n) Effect on the Extraction of Colour, Soluble Solids and Total Polyphenols from Green Tea When Treated With Fungal Cocktails

The yield in soluble solids increased by more than 15% when treated with ten-fold concentrated enzyme extracts from P. ostreatus var. florida, A. japonicus and L. edodes (Table 20), while the ten-fold concentrated extract of A. japonicus yielded an increase of more than 10% in total polyphenols. The levels of aspalathin and nothofagin from green tea were increased by 57% and 43% for P. ostreatus var. florida, 32% and 26% for L. edodes, and 12% and 19% for A. japonicus, respectively (Table 21). Although there were reduced levels for some of the minor antioxidants, there was a 29% and 17% increase in the total polyphenol content (% Total Flavonoids/SS) for P. ostreatus var. florida and L. edodes, respectively.

TABLE 20
Improvement in soluble solids (% SS), total polyphenols (TP) and colour determinants from green Rooibos tea after treatment with
fungal cocktails prepared in potato dextrose medium.

| | % SS | TP | % TP/SS | | | | | | |
|---|---|---|---|---|---|---|---|---|---|
| Treatment | (g SS/100 g | (mg GAE/ | (mg GAE/ | Colour - Rooibos extract | | | Colour - Rooibos leaves | | |
| of green tea | dry leaves) | g tea) | 100 g SS) | L* | a* | b* | L* | a* | b* |
| Control - Potato | 18.00 ± 0.68 | 2.82 ± 0.03 | 16.51 ± 1.06 | 82.72 ± 4.43 | −0.86 ± 0.59 | 78.64 ± 1.80 | 30.63 ± 0.23 | 11.82 ± 0.15 | 21.45 ± 0.23 |
| Dextrose | | | | | | | | | |
| P. ostreatus | 20.48 ± 1.07 | 4.58 ± 0.30 | 22.36 ± 0.45 | 85.20 ± 0.14 | −2.55 ± 0.04 | 74.91 ± 0.06 | 28.30 ± 0.07 | 12.37 ± 0.05 | 20.44 ± 0.20 |
| var. florida | | | | | | | | | |
| (10x | | | | | | | | | |
| concentrated) | | | | | | | | | |
| % | 118 | 108 | 92 | 100 | 101 | 109 | 89 | 105 | 92 |
| A. japonicus | ^{#}22.37 ± 0.76 | 4.79 ± 0.15 | 21.40 ± 0.42 | 84.86 ± 0.10 | −1.92 ± 0.01 | 79.32 ± 0.48 | 29.67 ± 0.08 | 12.48 ± 0.07 | 21.88 ± 0.11 |
| (10x | | | | | | | | | |
| concentrated) | | | | | | | | | |
| % | 129 | 113 | 88 | 100 | 76 | 116 | 93 | 106 | 98 |
| L. edodes | 20.07 ± 0.00 | 3.99 ± 0.00 | 19.87 ± 0.09 | 84.25 ± 0.53 | −1.93 ± 0.02 | 79.31 ± 0.49 | 27.63 ± 0.11 | 12.42 ± 0.07 | 19.81 ± 0.13 |
| (10x | | | | | | | | | |
| concentrated) | | | | | | | | | |
| % | 116 | 94 | 81 | 99 | 77 | 116 | 87 | 105 | 89 |

(1) Results are given as the means of duplicate or triplicate measurements, expressed as % relative to respective controls.
(2) Deviations of more than 10% from the respective controls are indicated in bold.
^{#}Indicate significant differences in means on a 5% (p < 0.05) significance level

TABLE 21
HPLC analysis of the effect of fungal enzyme treatment on the release of ten antioxidants from green Rooibos tea leaves.

| | | | | | | | Isoquer/ | | |
|---|---|---|---|---|---|---|---|---|---|
| Treatment | Asp | Orient | Iso orien | Vitex | Noth | Isovitex | Rutin | % Tot Flav/SS | % Tot Flav/TP |
| Control - Potato Dextrose | 2.000 | 0.640 | 0.775 | 0.204 | 0.124 | 0.196 | 0.286 | 4.24 ± 0.34 | 27.43 ± 2.13 |
| P. ostreatus var. florida | 3.149 | 0.668 | 0.825 | 0.200 | 0.177 | 0.216 | 0.239 | 5.49 ± 0.11 | 30.21 ± 0.90 |
| % | 157 | 104 | 106 | 98 | 143 | 110 | 84 | 129 | 110 |
| L. edodes | 2.631 | 0.693 | 0.845 | 0.217 | 0.156 | 0.213 | 0.179 | 4.94 ± 0.04 | 26.34 ± 0.47 |
| % | 132 | 108 | 109 | 107 | 126 | 109 | 63 | 117 | 96 |
| Control - Potato dextrose | 3.783 | 0.689 | 1.000 | 0.480 | 0.175 | 0.172 | 0.465 | 6.44 ± 0.12 | 26.37 ± 1.18 |
| A. japonicus | 4.245 | 0.643 | 0.835 | 0.115 | 0.208 | 0.156 | 0.438 | 6.67 ± 0.94 | 31.15 ± 4.24 |
| % | 112 | 93 | 84 | 24 | 119 | 91 | 94 | 104 | 118 |

*Abbreviations for antioxidants: Asp, aspalathin; Orient, orientin; Isoorien, isoorientin; Vitex, Vitexin, Noth, nothofagin, Isovitex, isovitexin; Isoquer/Rutin, isoquercitrin/Rutin; Quer, quercetin; Luteol, luteolin; Chrys, chrysoeryol
(1) Results are given as the means of duplicate or triplicate measurements, expressed as % relative to respective controls.
(2) Deviations of more than 10% from the respective controls are indicated in bold.
# Indicate significant differences in means on a 5% (p < 0.05) significance level

The L. edodes cocktail prepared in YP-wheat straw medium improved both the aroma and colour development from green tea (Table 22), which was also reflected in the colour of the Rooibos extract and leaves (Table 23, lower L*, higher a* and b* values). The concentrated L. edodes YP-wheat straw cocktail increased the yield in soluble solids by 17%, but this coincided with a decrease in the antioxidant content, suggesting the extraction of compounds with low antioxidant content. The R. oryzae potato dextrose cocktails improved the % TP/SS ratio of the Rooibos extract by more than 10%, and HPLC analyses confirmed an increase of more than 25% in the flavonoid content (% Flavonoids/SS) as well as an increase in the levels of most of the major antioxidants in Rooibos (Table 24).

TABLE 22
Effect of fungal cocktails prepared in YP-wheat straw
medium on aroma and colour development from green tea.

| Isolate | Aroma and Colour development |
|---|---|
| Control - YP + | Underfermented |
| wheat straw | |
| A. niger | Musty, dusty aroma with unidentified, |
| | uncharacteristic note |
| R. oryzae | Similar to control |
| L. edodes | Strange, nutty aroma. Well |
| | fermented character. Colour very good |
| P. ostreatus | Strange aroma with |
| var. florida | underfermented character |
| P. djamor | Vague sweet aroma development. |
| | Better than concentrated sample |

TABLE 23
Laboratory scale treatment of green tea with fungal cocktails.

| | % SS | TP | % TP/SS | | | | | | |
|---|---|---|---|---|---|---|---|---|---|
| Treat- | (g SS/100 g | (mg GAE/ | (mg GAE/ | Colour - Rooibos extract | | | Colour - Rooibos leaves | | |
| ment | dry leaves) | 100 g SS) | 100 g SS) | L* | a* | b* | L* | a* | b* |
| Con- | 13.28 ± 0.48 | 3.87 ± 0.17 | 29.12 ± 0.21 | 83.96 ± 0.49 | 1.13 ± 0.00 | 25.88 ± 0.61 | 30.38 ± 0.58 | 7.41 ± 0.07 | 12.56 ± 0.31 |
| trol - | | | | | | | | | |
| YP + | | | | | | | | | |
| wheat | | | | | | | | | |
| straw | | | | | | | | | |
| L. | 14.42 ± 0.25 | 3.83 ± 0.10 | 26.55 ± 0.24 | ^{#}78.36 ± 1.14 | −0.61 ± 1.25 | ^{#}42.36 ± 0.03 | 26.50 ± 0.36 | 10.16 ± 0.59 | 11.48 ± 0.37 |
| edodes | | | | | | | | | |
| (uncon- | | | | | | | | | |
| cen- | | | | | | | | | |
| trated) | | | | | | | | | |
| % | 109 | 99 | 91 | 93 | 54 | 164 | 87 | 137 | 91 |
| L. | 15.57 ± 0.79 | ^{#}3.01 ± 0.09 | ^{#}19.40 ± 1.54 | ^{#}74.87 ± 1.07 | ^{#}4.70 ± 0.83 | ^{#}44.45 ± 0.00 | 23.53 ± 0.33 | 9.94 ± 0.04 | 10.17 ± 0.59 |
| edodes | | | | | | | | | |
| (10x | | | | | | | | | |
| concen- | | | | | | | | | |
| trated) | | | | | | | | | |
| % | 117 | 78 | 67 | 89 | −417 | 172 | 77 | 134 | 81 |
| R. | 13.33 ± 0.07 | 3.89 ± 0.17 | 29.21 ± 1.40 | 84.43 ± 0.67 | −1.00 ± 0.35 | 26.34 ± 1.62 | 28.84 ± 0.11 | 7.48 ± 0.37 | 11.73 ± 0.19 |
| oryzae | | | | | | | | | |
| (uncon- | | | | | | | | | |
| cen- | | | | | | | | | |
| trated) | | | | | | | | | |
| % | 100 | 101 | 100 | 101 | 88 | 102 | 95 | 101 | 93 |
| R. | 13.92 ± 0.72 | 4.04 ± 0.21 | 29.03 ± 0.04 | 83.16 ± 1.87 | −0.47 ± 0.24 | 27.69 ± 0.63 | 29.24 ± 0.54 | 7.40 ± 0.43 | 11.97 ± 0.68 |
| oryzae | | | | | | | | | |
| (10x | | | | | | | | | |
| concen- | | | | | | | | | |
| trated) | | | | | | | | | |
| % | 105 | 105 | 100 | 99 | 42 | 107 | 96 | 100 | 95 |
| Con- | 14.11 ± 0.41 | 3.80 ± 0.08 | 26.94 ± 0.23 | 87.32 ± 1.26 | −1.02 ± 0.05 | 15.76 ± 0.58 | 28.97 ± 0.02 | 7.41 ± 0.41 | 12.46 ± 0.38 |
| trol - | | | | | | | | | |
| Potato | | | | | | | | | |
| Dex- | | | | | | | | | |
| trose | | | | | | | | | |
| L. | 13.91 ± 0.12 | 3.96 ± 0.09 | 28.45 ± 0.44 | 86.61 ± 0.26 | −0.97 ± 0.26 | 29.28 ± 0.30 | 28.60 ± 0.29 | 7.85 ± 0.11 | 12.44 ± 0.39 |
| edodes | | | | | | | | | |
| (uncon- | | | | | | | | | |
| cen- | | | | | | | | | |
| trated) | | | | | | | | | |
| % | 99 | 104 | 106 | 99 | 95 | 186 | 99 | 106 | 100 |
| L. | 14.06 ± 1.10 | 3.77 ± 0.22 | 26.82 ± 0.51 | 82.62 ± 1.34 | 0.48 ± 0.71 | 41.09 ± 0.62 | 25.69 ± 0.22 | 9.70 ± 0.21 | 11.58 ± 0.29 |
| edodes | | | | | | | | | |
| (10x | | | | | | | | | |
| concen- | | | | | | | | | |
| trated) | | | | | | | | | |
| % | 100 | 99 | 100 | 95 | −47 | 261 | 89 | 131 | 93 |
| R. | 12.59 ± 0.17 | 3.85 ± 0.10 | ^{#}30.58 ± 0.41 | 88.67 ± 0.06 | −1.30 ± 0.18 | 16.44 ± 0.73 | 30.01 ± 0.70 | 7.13 ± 0.62 | 12.87 ± 0.09 |
| oryzae | | | | | | | | | |
| (uncon- | | | | | | | | | |
| cen- | | | | | | | | | |
| trated) | | | | | | | | | |
| % | 89 | 101 | 114 | 102 | 127 | 104 | 104 | 96 | 103 |
| R. | 13.61 ± 1.04 | 4.16 ± 0.36 | ^{#}30.55 ± 0.29 | 87.39 ± 1.30 | −1.13 ± 0.12 | 24.50 ± 1.24 | 31.72 ± 0.20 | 7.13 ± 0.62 | 13.39 ± 0.43 |
| oryzae | | | | | | | | | |
| (10x | | | | | | | | | |
| concen- | | | | | | | | | |
| trated) | | | | | | | | | |
| % | 96 | 109 | 113 | 100 | 110 | 155 | 110 | 96 | 107 |

(1) Results are given as the means of duplicate or triplicate measurements, expressed as % relative to respective controls.
(2) Deviations of more than 10% from the respective controls are indicated in bold.
^{#}Indicate significant differences in means on a 5% (p < 0.05) significance level
*Quality parameters: 20 mg GAE/100 g SS (% TP/SS), 1 200 μmol Trolpx/g SS

TABLE 24
HPLC analysis of antioxidants extracted from green, fermented and spent Rooibos tea with fungal cocktails.

| | | | | | | | | | |
|---|---|---|---|---|---|---|---|---|---|
| | | | | | | | Iso-quer/ | | |
| Cocktail | Asp | Orient | Iso-orien | Vitex | Noth | Isovitex | Rutin | % Total Flavonoids/SS | % Total Flavonoids/TP |

Green Tea

| | | | | | | | | | |
|---|---|---|---|---|---|---|---|---|---|
| Control - YP + wheat straw | 3.246 | 0.648 | 0.749 | 0.175 | 0.325 | 0.208 | 0.869 | 6.245 ± 1.05 | 21.433 ± 0.49 |
| R. oryzee (unconcentrated) | 3.590 | 0.711 | 0.825 | 0.2 | 0.365 | 0.223 | 0.952 | 6.897 ± 0.09 | 23.627 ± 0.63 |
| % | 111 | 110 | 110 | 114 | 112 | 107 | 110 | 110 | 110 |
| Control - Potato Dextrose | 3.063 | 0.549 | 0.639 | 0.147 | 0.303 | 0.176 | 0.743 | 5.646 ± 0.24 | 20.957 ± 0.73 |
| R. oryzae (unconcentrated) | 4.004 | 0.659 | 0.768 | 0.172 | 0.393 | 0.208 | 0.897 | 7.128 ± 0.33 | 23.302 ± 0.81 |
| % | 131 | 120 | 120 | 117 | 130 | 117 | 121 | 126 | 111 |
| R. oryzae (10x concentrated) | ^{#}4.463 | 0.711 | 0.825 | 0.186 | ^{#}0.441 | 0.224 | 0.969 | ^{#}7.849 ± 0.24 | 25.694 ± 0.60 |
| % | 146 | 129 | 129 | 127 | 145 | 126 | 131 | 139 | 123 |

Fermented Tea

| | | | | | | | | | |
|---|---|---|---|---|---|---|---|---|---|
| Control - Potato Dextrose | 0.515 | 0.091 | 0.062 | 0.163 | 0.048 | 0.073 | 0.520 | 1.474 ± 0.08 | 5.795 ± 0.40 |
| R. oryzae (unconcentrated) | ^{#}0.683 | ^{#}0.111 | ^{#}0.074 | ^{#}0.193 | ^{#}0.064 | 0.086 | 0.639 | ^{#}1.849 ± 0.06 | 6.479 ± 0.08 |
| % | 133 | 121 | 119 | 118 | 130 | 117 | 123 | 126 | 112 |
| R. oryzae (10x concentrated) | ^{#}0.691 | ^{#}0.116 | ^{#}0.076 | ^{#}0.201 | ^{#}0.064 | ^{#}0.100 | 0.641 | ^{#}1.890 ± 0.02 | 6.542 ± 0.18 |
| % | 134 | 127 | 122 | 123 | 130 | 137 | 123 | 128 | 113 |

Spent tea

| | | | | | | | | | |
|---|---|---|---|---|---|---|---|---|---|
| Control - Potato Dextrose | 0.213 | 1.126 | 1.411 | 0.196 | 0.091 | 0.254 | 0.090 | 3.34 ± 0.19 | 21.96 ± 3.20 |
| MP1 - R. oryzae | 0.263 | ^{#}1.742 | ^{#}2.237 | ^{#}0.315 | ^{#}0.128 | ^{#}0.382 | 0.206 | ^{#}5.36 ± 1.10 | 20.46 ± 1.82 |
| % | 123 | 155 | 159 | 161 | 141 | 150 | 228 | 160 | 93 |

*Abbreviations for antioxidants: Asp, aspalathin; Orient, orientin; Isoorien, Isoorientin; Vitex, Vitexin, Noth, nothofagin, Isovitex, isovitexin; Isoquer/Rutin, isoquercitrin/Rutin; Quer, quercetin; Luteol, luteolin; Chrys, chrysoeryol.
(1) Results are given as the means of duplicate measurements, expressed as % relative to respective controls.
(2) Deviations of more than 10% from the respective controls are indicated in bold.
^{#}Indicate significant differences in means on a 5% (p < 0.05) significance level

### (o) Effect on the Release of Soluble Solids and Total Polyphenols from Fermented Tea When Treated With Fungal Cocktails

On fermented tea, the R. oryzae cocktail cultured in YP-wheat straw improved the yield in SS from fermented tea by more than 20% without a loss in antioxidant content (Table 25). When treated with the potato dextrose cocktail, there was no increase in soluble solids, but a more than 10% improvement in the antioxidant content (Table 25) and the levels of all the major antioxidants in Rooibos tea (Table 24).

TABLE 25
Laboratory scale treatment of fermented tea with R. oryzae cocktails.

| | | % TP/SS | |
|---|---|---|---|
| | % SS | (*mg | Antioxidant |
| | (g SS/100 g | GAE/100 g | (*μmol |
| Cocktail | dry leaves) | SS) | Trolox/g SS) |
| Control - YP + wheat straw | 7.72 | 29.54 | 2024 |
| R. oryzae | 9.48 | 30.06 | 1942 |
| % | 123 | 102 | 96 |
| R. oryzae (10x concentrated) | ^{#}11.33 | ^{#}29.18 | 1914 |
| % | 147 | 99 | 95 |
| Control - Potato Dextrose | 12.53 | 25.45 | 1547 |
| R. oryzae | 11.58 | 28.54 | 1732 |
| % | 92 | 112 | 112 |
| R. oryzae (10x concentrated) | 11.45 | 28.92 | 1752 |
| % | 91 | 114 | 113 |

*Quality parameters: 20 mg GAE/100 g SS (% TP/SS), 1 200 μmol Trolox/g SS
(1) Results are given as the means of duplicate measurements, expressed as % relative to respective controls.
(2) Deviations of more than 10% from the respective controls are indicated in bold.
^{#}Indicate significant differences in means on a 5% (p < 0.05) significance level

The lower efficacy of the potato dextrose cocktail in the extraction of soluble solids from fermented Rooibos tea could be due to the lower levels of endoglucanase and xylanase in the YP-wheat straw cocktail than in the potato dextrose cocktail (Table 26).

TABLE 26
Enzyme activities in R. oryzae cocktails.

| | Activity (IU/ml) | | | |
|---|---|---|---|---|
| Cocktail | Endoglucanase | Pectinase | Xylanase | Laccase |
| YP + wheat straw | | | | |
| (Day 5) | | | | |
| R. oryzae | 3.2 | 0.9 | 47.0 | 158.1 |
| R. oryzae (10x | 8.1 | 1.2 | 344.5 | 583.7 |
| concentrated) | | | | |
| Potato Dextrose | | | | |
| (Day 5) | | | | |
| R. oryzae | 2.1 | 1.2 | 0.7 | 3.2 |
| R. oryzae | 2.3 | 3.4 | 0.6 | 73.8 |
| (10x concentrated) | | | | |

(1) Results are given as the means of duplicate or triplicate measurements, expressed as % relative to respective controls.

### (p) Effect on the Extraction of Soluble Solids and Total Polyphenols from Spent Tea When Treated With Fungal Cocktails

The yield in soluble solids from spent tea increased by more than 20% when treated with crude enzyme extracts from A. japonicus, P. ostreatus var. florida and P. djamor (Table 27). More than 20% increase in TP was obtained with L. edodes, A. ficuum, P. candidum, P. citzinopileatus, P. ostreatus var. florida, P. djamor, MP1 and MP3.

TABLE 27
Improvement in soluble solids (% SS), total polyphenols
(TP) and colour determinants from spent Rooibos tea
leaves after treatment with fungal cocktails.

| | % SS | TP (mg | % TP/SS (mg |
|---|---|---|---|
| | (g SS/100 g | GAE/g | GAE/100 g |
| Treatment of spent tea | dry leaves) | tea) | SS) |
| Control - Potato | 5.32 ± 0.19 | 1.13 ± 0.12 | 21.31 ± 2.95 |
| Dextrose | | | |
| A. japonicus | ^{#}7.07 ± 0.17 | 1.09 ± 0.05 | 15.38 ± 1.08 |
| % | 133 | 96 | 73 |
| MP1 - R. oryzae | 4.18 ± 0.70 | 1.07 ± 0.05 | 26.05 ± 5.51 |
| % | 74 | 136 | 169 |
| MP3 - R. pusillus | 4.99 ± 0.07 | 1.04 ± 0.00 | 20.77 ± 0.33 |
| % | 88 | 132 | 135 |
| A. ficuum | 5.51 ± 0.02 | 0.96 ± 0.04 | 17.38 ± 0.61 |
| % | 97 | 122 | 113 |
| control - Potato | 4.92 ± 0.60 | 0.91 ± 0.04 | 18.70 ± 3.18 |
| Dextrose | | | |
| P. candidum | 5.03 ± 0.35 | ^{#}1.10 ± 0.03 | 21.97 ± 0.99 |
| % | 102 | 121 | 117 |
| P. citzinopileatus | 5.56 ± 0.38 | ^{#}1.10 ± 0.02 | 19.80 ± 1.65 |
| % | 113 | 120 | 106 |
| P. ostreatus var. | ^{#}6.83 ± 0.32 | ^{#}1.13 ± 0.00 | 16.47 ± 0.84 |
| florida | | | |
| % | 139 | 124 | 88 |
| P. djamor | ^{#}6.98 ± 0.02 | ^{#}1.16 ± 0.03 | 16.67 ± 0.38 |
| % | 142 | 127 | 89 |
| Control - Potato | 17.28 ± 0.05 | 2.67 ± 0.01 | 15.47 ± 0.24 |
| Dextrose | | | |
| L. edodes | 17.30 ± 0.70 | 3.24 ± 0.18 | 18.75 ± 0.11 |
| % | 100 | 121 | 121 |

(1) Results are given as the means of duplicate or triplicate measurements, expressed as % relative to respective controls.
(2) Deviations of more than 10% from the respective controls are indicated in bold.
^{#}Indicate significant differences in means on a 5% (p < 0.05) significance level

On spent tea, the most significant effect was obtained with the enzyme extract from MP1 (identified as R. oryzae), which improved the extraction of aspalathin, nothofagin and most of the minor compounds (Table 24), resulting in a 60% increase in the flavonoid content of the soluble solids (% Total Flavonoids/SS).

The Applicant believes that the processes in accordance with the invention may be used to obtain improved yield in aroma, colour, soluble solids and/or antioxidants from treatment of green, fermented or spent Rooibos plant material. This invention is directed to the production of Rooibos tea made by infusion and the production of tea extracts from green, fermented or spent tea material. The processes in accordance with the invention result in reduced production costs with improved efficiency and a greatly improved product.

The following references are incorporated herein by reference:

Bailey M. J., Biely P. and Poutanen K. (1992) Interlaboratory testing of methods for assay of xylanase activity. J. Biotechnol. 23: 257-270.

Domsch K. H., Gams W. and Anderson T. H. (1980) Compendium of soil fungi. Vol 1 Academic Press, London.

Fell J. W., Boekhout T., Fonseca A., Scorzetti G. and Statzell-Tallman A. (2000) Biodiversity and systematics of basidiomycetous yeasts as determined by large-subunit rDNA D1/D2 domain sequence analysis. International Journal of Systematic and Evolutionary Microbiology 50: 1351-1371.

Jonsson L. H., Saloheimo M. and Pentilla M. (1997) Laccase from the white-rot fungus Trametes versicolor cDNA cloning and expression in Pichia pastoris Curr. Genet 32: 425-430

Joubert E. (1995) Tristimulus colour measurement of Rooibos extracts as an objective quality parameter. International Journal of Food Science and Technology 30:783-792.

Joubert E. (1996) HPLC quantification of the dihyrochalcones, aspalathin and nothofagin in Rooibos tea (Aspalathus linearis) as affected by processing. Food Chemistry 55:403-411.

Kersters-Hilderson H., Claeyssens M., Van Dooslaer E., Saman E. and De Bruyne C. K. (1982) β-D-xylosidase from Bacillus pumilus. Methods Enzymol 83: 631-639.

Klich M. A. (2002). Identification of common Aspergillus species, Centraalbureau voor Schimmelcultures, Utrecht.

Miller G. L. (1959) Use of dinitrosalicyclic acid reagent for determination of reducing sugars. Anal. Chem.31: 426-428.

Poutanen K. and Puls J. (1988) Characteristics of Trichoderma reesei β-xylosidase and its use in the hydrolysis of solubilised xylans. Appl. Microbiol. Biotechnol. 28: 425-432.

Raeder U. and Broda P. (1985) Rapid preparation of DNA from filamentous fungi. Letters in Applied Microbiology 1:17-20.

Re R., Pellegrini N., Proteggente A., Pannala A., Yang M. and Rice-Evans, V. (1999) Antioxidant activity applying an improved ABTS radical cation assay. Free Radical Biology and Medicine 26:1231-1237.

Schipper M. A. A. (1973) A survey on variability in Mucor heimalis and related species. Studies in Mycology 7:1-40.

Schipper M. A. A. (1975) On Mucor mucedo, Mucor flavus and related species. Studies in Mycology 10:1-33.

Schipper M. A. A. (1976) On Mucor circinelloides, Mucor racemosus and related species. Studies in Mycology 12:1-40.

Schipper M. A. A. (1978) On certain species of Mucor with a key to all accepted species. Studies in Mycology 25:1-52.

Schipper M. A. A. (1984) The Rhizopus stolonifer-group and Rhizopus oryzae. Studies in Mycology 17:1-19.

Singleton V. L. and Rossi J. A. (1965) Colorimetry of total phenolics with phosphotungstic acid reagents. American Journal of Enology and Viticulture 16:144-158.

White T. J., Bruns T., Lee S. and Taylor J. (1990). Amplification and direct sequencing of fungal ribosomal RNA genes for phylogenetics. In M A Innis, D H Gelfand, J J Sninsky & T J White (Eds). PCR Protocols (pp 315-322) Academic Press, San Diego.

A number of embodiments of the invention have been described. Nevertheless, it will be understood that various modifications can be made without departing from the spirit and scope of the invention. Accordingly, other embodiments are within the scope of the following claims.

1-9. (canceled)

10. A process of treating Rooibos plant material to obtain Rooibos tea extracts with improved soluble solids yield, said process including
contacting Rooibos plant material with an effective amount of at least one exogenous hydrolytic enzyme, the process being carried out at a temperature of 20° C. to 50° C. under predetermined conditions, thereby to obtain Rooibos tea extracts having a soluble solids yield of at least 10% soluble solids (gram soluble solids per 100 ml tea extract) more than without enzyme treatment.

11. A process as claimed in claim 10, wherein the enzyme is selected from at least one from the group consisting of Cellulase 13L, Depol 112L, Depol 670L, Depol 692L, Depol 740L, Glucanase 5XL, Pectinex Ultra SP-L, Ultraflo L or Ultrazym P.

12. A process as claimed in claim 10, wherein the enzyme is selected from at least one from the group consisting of pectinase, ferufic acid esterase, β-glucanase, cellobiohydrolose, β-xylanase, β-glucosidase and β-xylosidase.

13. A process as claimed in claim 10, wherein the enzyme is derived from a fungal strain selected from the group consisting of Aspergillus, Lentinula, Penicillium, Pleurotus, Trichoderma, Rhizopus, Rhizomucor, Neurospora and Paecilomyces species.

14. A process as claimed in claim 10, wherein the process is carried out with said enzyme being provided at a dosage of 0.01 U-1000 U per g Rooibos plant material.

15. A process as claimed in claim 10, wherein the Rooibos plant material is selected from at least one of green (unfermented) tea and fermented tea.

16. A process as claimed in claim 10; wherein the process is carried out at a pH of 4 to 7.

17. A process as claimed in claim 10, wherein the process is carried out for a period of 2 to 3 hours.
